(19) United States
(12) Patent Application Publication
(10) Pub. No.: US 2024/0100533 A1
(43) Pub. Date: Mar. 28, 2024

(54) Device for Thermocycled Multistep Reactions

(71) Applicant: SYNHELIX, Evry-Courcouronnes (FR)

(72) Inventors: Irina RANDRIANJATOVO-GBALOU, Evry-Courcouronnes (FR); Ahmed SAID, Evry-Courcouronnes (FR)

(21) Appl. No.: 18/275,369

(22) PCT Filed: Feb. 4, 2022
(86) PCT No.: PCT/EP2022/052774

§ 371 Date: Aug. 1, 2023

(30) Foreign Application Priority Data
Feb. 5, 2021 (EP) 21305162.6

(51) Int. Cl. B01L 7/00; B01L 3/00

(52) U.S. Cl. CPC B01L 7/52; B01L 3/50255; B01L 3/50851; B01L 2300/0681; B01L 2300/185; B01L 2400/049

(57) ABSTRACT

Thermocycling multistep reaction device comprising a reaction plate (12) comprising at least one well (14) and at least one internal fluid circulation channel arranged around the at least one well (14), an evacuation system (16), a first circuit being aimed, when activated, at driving a first heat transfer fluid through the at least one internal fluid circulation channel, a second circuit being aimed, when activated, at driving a second heat transfer fluid through the at least one internal fluid circulation channel, and a control unit. The temperature inside the at least one well (14) is regulated and controlled by means of the control unit which selectively activates the circuits, each well (14) is connected to the evacuation system (16) by means of at least one filter membrane.

### FIELD OF INVENTION

The present invention relates to devices and methods enabling high-performance, scalable volume and automated handling of biological or chemical samples which are useful in the field of genomics, chemistry and biology for a variety of processes, including large-scale DNA amplification or de novo synthesis, gene expression analysis, chemical synthesis, cell sampling, and more particularly when thermocycled multistep reactions are implemented.

### BACKGROUND OF INVENTION

The synthesis of (macro)molecules and polymers, whether carried out chemically, biologically or biochemically, is a fundamental issue in modern industries, such as the pharmaceutical, food or petrochemical industries.

More particularly, the production and synthesis of de novo nucleic acids, whether single or double stranded, or specific cell cultures, is today a major pharmaceutical issue since the development of bio-therapeutic technologies. Bio-therapeutic technologies such as DNA/RNA vaccines, gene therapy or even cell therapy are taking an unprecedented boom. However, to be industrialized, these technologies require a large amount of genetic material with a high degree of purity, essential criteria to meet GMP standards.

Nowadays, the synthesis of nucleic acids is classically carried out in a chemical way by means of technologies based on the phosphoramidite approach. However, these technologies have the drawback of limiting, either the size of the strand synthesized or the final synthesis yield. Thus, for the production of a strand of 120 nucleotides, the final yield is typically less than 50%, without even considering the losses occurred during the purification steps and different necessary treatments to render the final product compatible for a pharmacological application.

The synthesis of nucleic acids by enzymatic method is therefore becoming an approach of interest. Indeed, certain enzymes naturally have the capacity to lengthen, repair and control nucleic acid sequences, in aqueous solutions that are not very harmful and with higher yields than chemistry.

However, obtaining those (macro)molecules usually require several successive or cyclic synthesis steps which generally further require intermediate purification steps. Thus, beyond the development of the synthesis methods themselves, a major obstacle for industries to succeed in large-scale synthesis of (macro)molecules and polymers is their lack of means and tools to be able to readily purify the reactions products between each synthesis step, meaning being able to separate the reaction products from unincorporated reagents, synthesis catalysts as well as reaction by-products.

In order to achieve those purification steps, several methods can be used, such as chromatography or electrophoresis (Syren et al., 2007. J Chromatogr B Analyt Technol Biomed Life Sci. 856(1-2):68-74). However, although these methods are very efficient and generally lead to extremely pure reaction products, the complexity, implementation time as well as very high cost of those methods, make them difficult to implement at an industrial scale.

This is why industries generally opt for simpler methods, such as filtration and ultrafiltration which allow rapid and less expensive separation of the reaction products from reaction by-products. For this, several types of (ultra)filtration devices have been developed such as the Amicon® and Centricon® modules, which use centrifugal force. Vacuum filtration devices, powered by a pump are also currently used. Those vacuum pumps allow the creation of a controlled depression between the filtrate (reaction products) and the retentate (reaction by-products). However, although very efficient, those devices are not suitable for simultaneously carrying out chemical and/or biochemical reactions in the device itself as they do not allow the effective and precise control, nor even the automation, of the temperature and the homogenization of the reaction medium.

Furthermore, laboratory automation has played a key role in the advancement of genomics, synthetic biology and drug discovery over the past decade. Levels of automation of the various steps vary, ranging from processes including manual steps, e.g., for the feeding of raw materials, to fully integrated processes. According to the final purpose, each configuration has demonstrated some advantages; however, in cases including some manual setups, there are significant issues with human error-resulting misinterpretation of results, a whole process labor which is more intensive; not to mention the risks of contamination when transferring from one system to another. Other laboratories utilize pipetting robots to accomplish these preparative steps (such as plate-to-plate liquid transfers, plate sealing, plate-thermocycling with magnetic beads, etc.), but these systems are complicated and expensive to build and may suffer from sample evaporation problems and volume constraints.

The current invention aims at solving the above-mentioned issues, by providing a thermocycling multistep reaction device and a method for synthesizing (macro)molecules using said device, such as, for example, nucleic acids, by enzymatic means, in large industrial quantities, with a high level of purity and whose length in sequence is 10 to 20 times longer and higher than chemical synthesis.

### SUMMARY

This invention thus relates to a thermocycling multistep reaction device comprising:
a reaction plate comprising at least one well aimed at receiving a reaction solution or a reaction tube, and further comprising at least one internal fluid circulation channel arranged around the at least one well,
an evacuation system,
a first circuit comprising a first pump and a first thermostat, said first circuit being activable and being aimed, when activated, at driving a first heat transfer fluid through the at least one internal fluid circulation channel,
an second circuit comprising a second pump and a second thermostat, said second circuit being activable and being aimed, when activated, at driving a second heat transfer fluid through the at least one internal fluid circulation channel,
a control unit managing the activation of the first circuit and the second circuit,
   wherein the temperature inside the at least one well is regulated and controlled by means of the control unit:
   the activation of the first circuit enabling to set and maintain the at least one well at a predetermined high temperature,
   the activation of the second circuit enabling to seta and maintain the at least one well at a predetermined low temperature, said low temperature being lower than the high temperature, and
   the activation of both circuits enabling to set and maintain the at least one well at at least one predetermined medium temperature, said at least one medium temperature being comprised between the high and the low temperature,
      wherein each well is connected to the evacuation system by means of at least one filter membrane.

This way, the solution enables to reach the here-above mentioned objective. Especially, solving the quantity and purity issues through the development of a temperature controlled modular vacuum filtration device that can accommodate one or several independent reaction chambers embodied by each well. The reaction temperature inside each reaction chamber is thus controlled by the circulation of a fluid in the heart of the device, enabling a series of controlled temperature variations depending on the reaction parameters. On the other hand, the products purity is controlled by the controlled use of a specific membrane with determined pore size. Further, if the device is installed on a steering system, the chemical and thermal homogenizations of the reaction medium can safely be obtained by orbital or linear stirring without the need to move the device. There is thus no necessity to transfer the reaction solution from a first device to a second device, to a further device between different reaction and/or purification steps. This, among other obvious safety and productivity advantages, enables all of those steps to be automated.

Thus, the device according to the present invention is particularly suitable, but not limited to the controlled synthesis of nucleic acids.

In some particular embodiment, the device may comprise a third circuit comprising a third pump and a third thermostat, said third circuit being activable and being aimed, when activated, at driving a third heat transfer fluid through the at least one internal fluid circulation channel,

the temperature inside the at least one well being regulated and controlled by means of the control unit:
the activation of the first circuit enabling to set and maintain the at least one well at the predetermined high temperature,
the activation of the second circuit enabling to set and maintain the at least one well at the predetermined low temperature,
the activation of the third circuit enabling either a rapid temperature decrease of the at least one well, or the setting and maintaining of the at least one well at a predetermined very low temperature, said very low temperature being lower than the low temperature,
the activation of at least two circuits enabling to set and maintain the at least one well at at least one predetermined medium temperature, said at least one medium temperature being comprised between the high and the very low temperature.

The device according to the invention may comprises one or several of the following features, taken separately from each other or combined with each other:
the reaction plate may comprise at least two separated internal fluid circulation channels, the two channels being designed to extend symmetrically regarding each other within the reaction plate, in order to improve temperature homogeneity inside the reaction plate,
the reaction plate may comprise at least two separated internal fluid circulation channels in order to enable a crossed flow circulation of the heat transfer fluid(s),
the first circuit may comprise a first external fluid circulation channel, said first external fluid circulation channel bypassing the reaction plate and being connected to each internal fluid circulation channel by means of a first activation valve, the opening of the first activation valve leading to the activation of the first circuit,
the second circuit may comprise a second external fluid circulation channel, said second external fluid circulation channel bypassing the reaction plate and being connected to each internal fluid circulation channel by means of a second activation valve, the opening of the second activation valve leading to the activation of the second circuit,
the third circuit may comprise a third external fluid circulation channel, said third external fluid circulation channel bypassing the reaction plate and being connected to each internal fluid circulation channel by means of a third activation valve, the opening of the third activation valve leading to the activation of the third circuit,
the predetermined high temperature may range from about 90 to about 110° C.,
wherein the predetermined low temperature may range from about −150 to about 19° C.,
the device may comprise one unique filter membrane for the entire reaction plate which displays the same surface as the reaction plate and connects all the wells to the evacuation system,
the device may comprise one filter membrane for each well of the reaction plate, each membrane connecting each corresponding well to the evacuation system,
each well may form an independent reaction chamber,
the device may comprise an integrated steering system.

A further object of the present invention is a thermocycled multistep method implemented by means of the device according to any one of the here above-mentioned technical features, said method comprising, in the order of listing, following steps:
filing the heating circuit, the reaction circuit and the third circuit with one or several heat transfer fluid(s),
activating the first pump and first thermostat, second pump and second thermostat, and, if present, the third pump and third thermostat,
inserting, if necessary, a reaction tube inside the at least one well and positioning the at least filter membrane between the at least one well and the evacuation system,
filing each well or each reaction tube with a reaction solution,
selectively activating and disactivating over time, by means of the control unit, the first circuit, the second circuit and, if present, the third circuit according to a predetermined reaction protocol,
activating the evacuation system when all the reaction steps according to reaction protocol are completed,
recovering the reaction product.

The method may further comprise a downstream application on the reaction product before it is recovered.

### BRIEF DESCRIPTION OF THE DRAWINGS

The invention will be better understood, and other aims, details, characteristics and advantages thereof will emerge more clearly on reading the detailed description which follows, of one or several embodiments of the invention given by way of illustration. Those are purely illustrative and non-limiting examples, with reference to the accompanying schematic drawings.

On these drawings:

FIG. 1 is a general overall perspective view of a device according to the present invention,

FIG. 2 is an expanded view of the device according to the present invention,

FIG. 3 is a view from above of the device according to the present invention,

FIG. 4 is a profile section of the reaction plate and the evacuation system of the device according to the present invention,

FIG. 5 is a profile section diagram showing the internal fluid circulation channels inside the reaction plate of the device according to the present invention,

FIG. 6 is a schematic fluid circulation diagram of the device according to the present invention.

FIGS. 7a and 7b are a schematic representation of a reaction carried out in a device according to the present invention.

### DETAILED DESCRIPTION

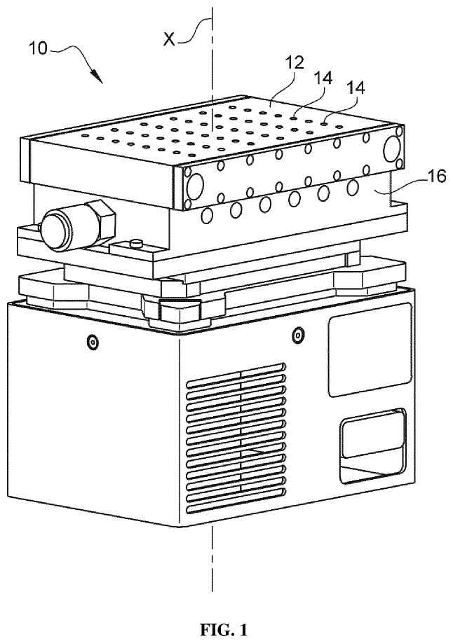

As can be seen on FIG. 1, the present invention relates to a thermocycling multistep reaction device 10, in particular to a thermocycling synthesis device 10 comprising:
a reaction plate 12 comprising at least one well 14 aimed at receiving a reaction solution or a reaction tube,
an evacuation system 16,
a first circuit 18 comprising a first pump P₁,
a second circuit 20 comprising a second pump P₂,
a third circuit 22 comprising a third pump P₃,
a control unit 24 managing the activation of the first circuit 18, the second circuit 20 and the third circuit 22.

In some embodiments, the device 10 only comprises a first circuit 18 and a second circuit 20. However, the overall functioning of those two embodiments is similar on the principle, therefore the embodiment with three circuits 18, 20, 22 will be described by default and any relevant alternative technical feature of the embodiment with two circuits 18, 20 will be mentioned if different.

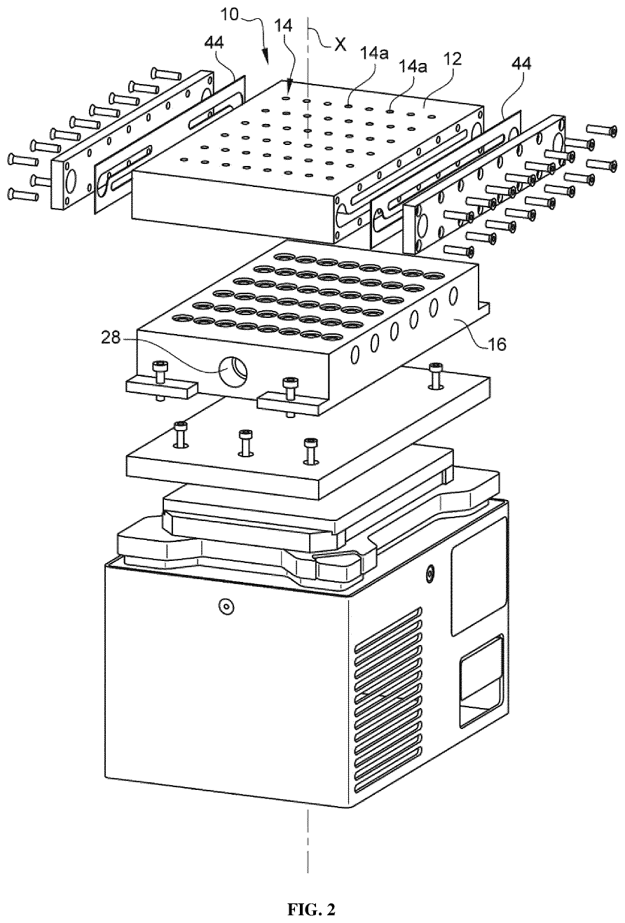

As can be seen on FIGS. 1 and 2, the reaction plate 12 extends within an agitation plane A, the device 10 being agitated within this plane. The device 10 further extends along a stacking axis X, said stacking axis X being perpendicular to the agitation plane A. In most cases, the agitation plane A is horizontal and the stacking axis X is vertical.

The reaction plate 12 displays a size ranging from about 100 to about 300 cm². More particularly regarding the depicted embodiment of FIGS. 1 and 2, the reaction plate 12 displays 24 wells, it displays a size of 15×8 cm.

Preferably, the reaction plate 12 displays the generic SBS format which enables the use of classical multichannel pipettes and further enables automatization of the well filling.

Each well 14 offers a volume ranging from about 250 to about 500 μm, depending on the number of wells 14 on the reaction plate 12.

The ANSI/SBS format is a well-known, by any person skilled in the art, standardization of microplates. Microplates are essential in research and development regarding biology. The ANSI/SBS standard was created to regulate their format and to enable the development of tools capable of supporting those microplates. The use of the ANSI/SBS format in the present invention allows it to be adapted to all the current robotic platforms (for example liquid handling robot) of the state of the art.

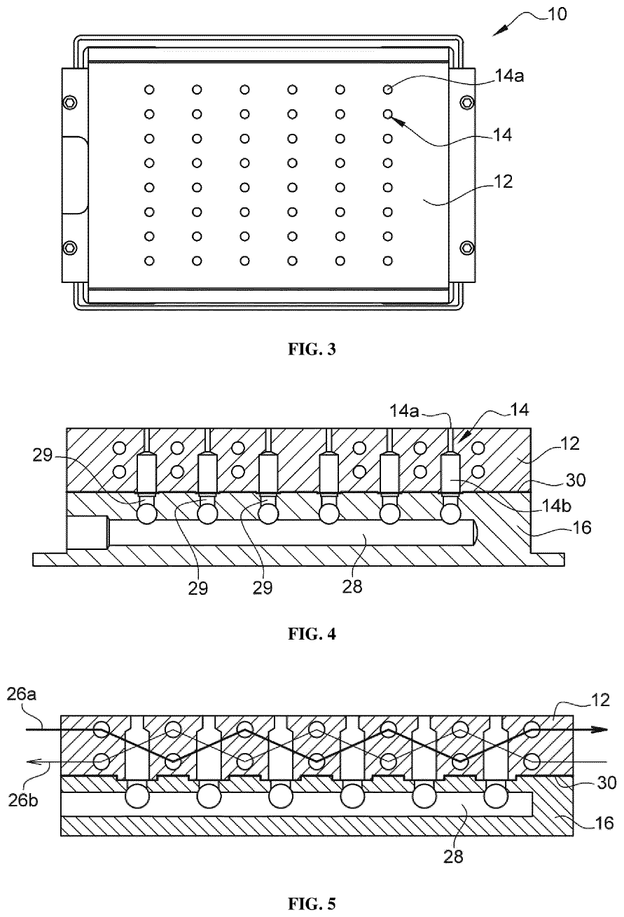

As can be seen on the embodiment depicted on FIG. 3, the reaction plate 12 comprises 24 wells. In another not represented embodiment, the reaction plate 12 can comprise 48 wells. More generally, the reaction plate 12 can comprise from 6 to 768 wells depending on the bio production needs. Additionally, a very high number of wells 14 allows “High-throughput Screening” methods. Obviously, the reaction volume can also be modulated according to the yield and the amount of final product to be obtained.

As can be seen on FIG. 4, each well 14 extends along the stacking axis X and 14 displays a general bottle shape with a narrow neck 14a on the upper side of the reaction plate 12 and a wider reservoir 14b on the lower side of the reaction plate 12. The reaction solution is this introduced through the neck of each well 14. This specific geometry minimizes the cross-contamination risk. The size of the wells 14 is further calculated to allow the thermoregulation liquid conduits to pass while respecting the well-known classical SBS format.

In some alternative embodiments, each well 14 is able to receive a reaction tube filled with the reaction solution.

Each well 14 thus forms an independent reaction chamber aimed, either at directly receiving the reaction solution or receiving a reaction tube filled with the reaction solution. Those reaction chambers enable that incubation, synthesis, biological or chemical reactions, filtration, washing, for each of their respective content takes place in parallel.

Preferably, each well 14 displays an internal coating suitable for the reaction, said internal coating enabling to prevent non-specific adsorption, on the well 14 walls, of reagents and reaction products. For example, the internal coating may comprise hyperhydrophobic coatings of the “low bind” type, such as Teflon® . The internal coating can also display a significant impact in the total elimination of reaction or washing solutions, for example in avoiding wetness and leading to zero drop remaining attached to the walls once the well 14 is emptied.

The wells 14 should be dimensioned such as to allow the use of a synthesis support, such as a bead. This type of method is observed in particular for the synthesis of PCR primers (100 nucleotides) but also for peptide synthesis (Fmoc chemistry) or even in vitro synthesis of proteins (cell-free system) or other types of polymers. The use of beads also makes it possible to consider protocols for the purification of proteins, nucleic acids or other compounds.

The evacuation system 16 displays a general rectangular block shape and forms the lower basis of the device 10, regarding the stacking axis X. This block is, for example, made of aluminum. The evacuation system 16 is in direct contact with the lower side of the reaction plate 12. Each well 14 is thus connected to the evacuation system 16 by its lower reservoir 14b. As can be seen on FIGS. 2, 4 and 5, the evacuation system 16 may comprise an evacuation channel 28 connected, by means of a quick-coupling 29 to each well 14. When activated, the evacuation system 16 enables to empty the wells 14 by evacuating the reaction solution. The evacuation system 16 may be activated by a vacuum pump (not represented) creating a vacuum sucking the remaining reaction solution out of the wells 14 into the evacuation channel 28 towards a collector (not shown). The collector enables the trapping of the evacuated reaction solution remains, and the generation of a pressure drop (depression) leading to reflux less liquid evacuation. In the absence of such a collector, the evacuated liquid could be at risk to fill the vacuum pump and damaging it.

In some embodiments, a steering system is integrated in the device 10 and is to be found under the evacuation system 16. This integrated steering system enables the chemical and thermal homogenizations of the reaction medium inside the wells 14 of the reaction plate 12 by orbital or linear stirring. The steering system might be a Hamilton® system. In an alternative embodiment, the device 10 may be safely secured on an independent steering system.

As can be seen on FIG. 4, each well 14 is connected to the evacuation system 16 by means of at least one filter membrane 30.

This (or those) filter membrane(s) 30 enable(s) to filter the reaction solution and to retain the reaction products inside the wells 14 when the evacuation system 16 is activated. Those reaction products might for example be nucleic acids.

This way, the device 10 integrate a vacuum filtration or ultrafiltration system (said (ultra) filtration system comprising the evacuation system 16 and each filter membrane 30) enabling a total separation of the reaction product of interest and reaction waste, without producing any dead volume. The purpose of the ultrafiltration system in the context of the synthesis of nucleic acids, for example, is to keep the reaction product of interest fixed on a soluble support, meaning a soluble membrane 30, while the used synthesis mixes pass, through vacuum suction (induced by the activation of the evacuation system 16), with the aqueous phase through the membrane 30, towards the evacuation system 16, and are then removed.

As can be seen on FIGS. 4 and 5, each well 14 displays, on its lower side, a ring 15 with a very light over-thickness to compress the membrane(s) 30 and ensure good inter-well sealing. Each membrane 30 is further maintained in place by means of the evacuation system 16.

In some embodiments, the device 10 comprises one unique filter membrane 30 which displays the same surface as the reaction plate 12 and connects all the wells 14 to the evacuation system 16. In an alternative embodiment, the device 10 comprises one filter membrane 30 for each well 14, each filter membrane displaying a size sensibly similar to the well lower reservoir 14b diameter.

The use of a unique filter membrane 30 for the complete reaction plate 12 allows the membrane 30 to be replaced quickly between two reaction processes.

The use of an individual membrane 30 for each well 14 complicates the change of membranes 30 between two reaction processes, but it allows to use different membranes types for different wells 14, thus allowing to vary the nature of the polymer, the size of the porosity. This is particularly advantageous when different fragments have to be synthesized.

The panel of membranes 30 that can be adapted to the device 10 is very wide. The membranes 30 can have pore sizes ranging from 3 kDa to 100 kDa for ultrafiltration and up to 1 μm for simple filtration. In cases where beads are used inside the wells 14, the pores of the membrane 30 can be large, around 1 um.

In the case of DNA synthesis, if the membrane 30 displays a pore size of 50 kDa, filtration by means of the vacuum pump will be able to eliminate enzymes which have a size less than 40 kDa as well as the reaction medium.

A particular application example is the PCR on high yield plasmid (PCR-prep): at the end of the synthesis, enzymes, nucleotides, pyrophosphate, salt (desalting), cofactors/DMSO are all evacuated towards the evacuation system 16 and the synthesized DNA strand remains in the wells 14, captive of the membrane 30. In a further step, the DNA strand can be washed and then recovered in TE buffer or in water depending on the downstream application without being transferred in another recipient or device, simply in activating or inactivating the evacuation system 16.

The membranes 30 can be of organic, inorganic or hybrid type and thus have variable chemical compositions. More particularly, the device 10 may comprise membranes 30 based on phlysophone (PS), polyethersulphone (PES), polyvinylidene fluoride (PVDF) polyacrylonitrile (PAN) and cellulose acetate (CA), Polytetrafluoroethylene (PTFE) but also based on ceramics, aluminum, zircon, titanium oxide, silica, mixture of silicon carbide and clay.

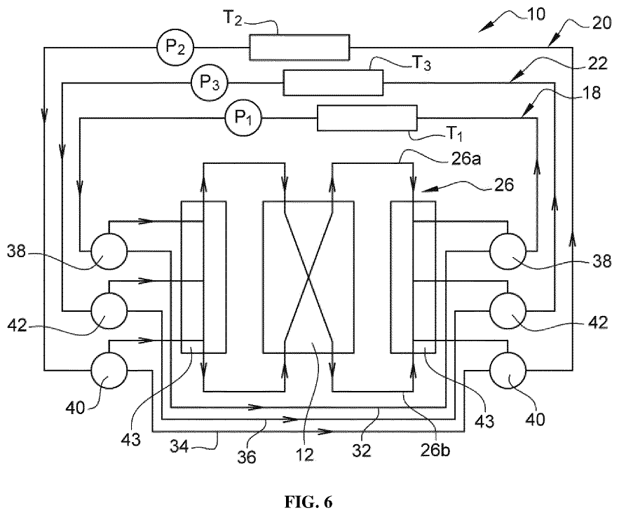

The reaction plate 12 further comprises at least one internal fluid circulation channel 26 arranged around the wells 14. This internal fluid circulation channel 26 aims at circulating heat transfer fluid through the reaction plate 12 in order to manage the wells 14 temperature. As can be seen on FIG. 5, said internal fluid circulation channel 26 extends in an undulated way across the reaction plate 12. It thus extends up and down regarding the stacking axis X all along the reaction plate 12. This enables a better homogenization of the temperature of the reaction plate 12, and thus of the wells 14, regarding the stacking axis X direction. As can further be seen of FIG. 6, the reaction plate 12 comprises at least two separated internal fluid circulation channels 26a, 26b, the two channels 26a, 26b, being designed to extend symmetrically regarding each other within the reaction plate 12, in order to improve temperature homogeneity inside the reaction plate 12. The two separated internal fluid circulation channels 26a, 26b further enable a crossed flow circulation of the heat transfer fluid(s), even further improving the temperature homogeneity inside the reaction plate 12. Thus, the progressive temperature loss along the fluidic circulation from the first side to the second side of the reaction plate 12 right is compensated by the fluidic circulation from the second side to the first side of the reaction plate 12.

As can be seen on FIG. 6, the first circuit 18 comprises a first external fluid circulation channel 32, said first external fluid circulation channel 32 is bypassing the reaction plate 12. Similarly, the second circuit 20 comprises a second external fluid circulation channel 34 and the third circuit 22 comprises a third external fluid circulation channel 36, said second and third external fluid circulation channel 34, 36 also bypassing the reaction plate 12. In the embodiment shown on FIGS. 1 and 2, the first, second and third external fluid circulation channel 32, 34, 36 are all connected independently and separately to the internal fluid circulation channels 26a, 26b of the reaction plate 12. More precisely, the first circuit 18 is connected to each internal fluid circulation channel 26a, 26b by means of a first activation valve 38, the second circuit 20 is connected to each internal fluid circulation channel 26a, 26b by means of a second activation valve 40, the third circuit 22 is connected to each internal fluid circulation channel 26a, 26b by means of a third activation valve 42.

The channels 26a, 26b, 32, 34 and 36 are preferably made of aluminum.

The first circuit 18, the second circuit 20 and the third circuit 22 The activation valves 38, 40, 42 are situated on the flanks of the reaction plate 12. Those activation valves 38, 40, 42 are all connected in series. They are, in some embodiments, electro-valves which are closed in an inactivated state and open in an activated state. Thus, when the electro-valves 38, 40, 42 are inactivated, the circuits 18, 20, 22, bypass the reaction plate 12 and the internal fluid circulation channels 26, 26a, 26b remain empty. The selective valve 38, 40, 42 opening and closing enables the control unit 24 to select which circuit 18, 20, 22 is to be connected to the internal fluid circulation channels 26, 26a, 26b of the reaction plate 12. In some embodiments, all the activation valves 38, 40, 42 are regrouped inside a manifold 43 (see FIG. 6). Each electro-valve has to be able to ensure a wide temperature range. In particular the temperature of the first circuit 18 induces the use of an alternative current piloted coil.

In the embodiment depicted in FIGS. 1 and 2, the activation valves 38, 40, 42 are situated externally to the reaction plate 12 and the first, second and third external fluid circulation channel 32, 34, 36 all surround the reaction plate 12.

Safety is ensured by means of a circuit breaker (not represented).

The sealing of the device 10 is ensured by means of side seals 44 as can be seen on FIGS. 2 and 3.

The first circuit 18, the second circuit 20 and the third circuit 22 can each been activated by the control unit 24. More precisely:
the opening of the first activation valve 38 leads to the activation of the first circuit 18,
the opening of the second activation valve 40 leads to the activation of the second circuit 20,
the opening of the third activation valve 42 leads to the activation of the third circuit 22.

The first circuit 18 is thus activable and is aimed, when activated, at driving a first heat transfer fluid through each of the internal fluid circulation channels 26a, 26b. The second circuit 20 is thus also activable and is aimed, when activated, at driving a second heat transfer fluid through each internal fluid circulation channels 26a, 26b. The third circuit 22 is thus also activable and is aimed, when activated, at driving a third heat transfer fluid through each internal fluid circulation channels 26a, 26b. The selective valve 38, 40, 42 opening and closing enables the control unit 24 to select which heat transfer fluid, at which temperature, is to be driven through the reaction plate 12.

The fluid driving of each circuit 18, 20, 22 is done by means of, respectively, the first, second and third pumps P₁, P₂, P₃. The temperature of each circuit 18, 20, 22 is achieved and/or maintained and/or modified by means of a thermostat T₁, T₂, T₃ included inside each circuit 18, 20, 22. It can, for example, be a Minichiller®.

This leads the temperature inside the wells 14 to be regulated and controlled by means of the control unit 24, more precisely by means of the heat transfer fluid management circulating (or not) through the reaction plate 12. This heat transfer fluid management is done by:
the activation of the first circuit 18 enabling to set and maintain the wells 14 at a predetermined high temperature,
the activation of the second circuit 20 enabling to set and maintain the wells 14 at a predetermined low temperature, said low temperature being lower than the high temperature,
the activation of the third circuit 22 enabling either a rapid temperature decrease of the wells 14 or the setting and maintaining of the at least one well 14 at a predetermined very low temperature, said very low temperature being lower than the low temperature, and
the activation of at least two circuits 18, 20, 22 enabling to set and maintain the at least one well 14 at at least one predetermined medium temperature, said at least one medium temperature being comprised between the high and the very low temperature.

Depending on the carried-out reaction, there might be several predetermined medium temperatures at which the wells have to be set and/or maintained at some points during the reaction.

Regarding the embodiment with only a first circuit 18 and a second circuit 20, the heat transfer fluid management is done by:
the activation of the first circuit 18 enabling to set and maintain the wells 14 at a predetermined high temperature,
the activation of the second circuit 20 enabling to set and maintain the wells 14 at a predetermined low temperature, said low temperature being lower than the high temperature,
the activation of both circuits 18, 20 enabling to set and maintain the at least one well 14 at least one predetermined medium temperature, said at least one medium temperature being comprised between the high temperature and the low temperature.

The predetermined high temperature ranges from about 90 to about 110° C., and more specifically the predetermined high temperature is set at 95° C. The predetermined low temperature ranges from about 20 to about 90° C., and more specifically the predetermined low temperature is set at 70° C. The predetermined very low temperature ranges from about −150 to about 19° C.

Temperature control is essential during any kind of chemical or biological synthesis, and in particular for enzymatic synthesis. In particular regarding the enzymatic synthesis of nucleic acids, temperature control is essential for two main reasons:
an enzyme has an optimum temperature for which its activity will be the most efficient,
temperatures ranging from about 90 to about 110° C. denature the nucleic acid strands and keep them in this state to ensure that they are taken care of by the enzymes.

The heat transfer fluids may all be different fluids or may all be the same. It might for example be water, as water is a very good heat transferring fluid and displays no particular danger except the heat regarding the temperature of the fluid inside the first circuit 18. Using the same heat transfer fluid also avoids the mixing of different fluids inside the internal fluid circulation channels 26, 26a, 26b.

In other embodiments, the fluid may be and the third circuit 22 may thus enable the temperature of the wells 14 to lower down to −150° C. In this embodiment, the first circuit may enable the temperature of the wells 14 to rise up to 200° C. in less of 1 minute.

Contrary to current solutions providing temperature control by an external independent support that can be heated or refrigerated, leading the heat exchanges to take place only through one or more faces of the bioreactor, in the current invention, the circulation of at least one fluid through internal fluid circulation channels 26, 26a, 26b allows rapid temperature changes of the wells 14 as the heat transfer fluids are brought as close as possible to the wells 14. In the state of the art, the homogeneity and the change in temperature of the wells are entirely dependent on the thermal conductivity of the support, inducing slow temperature transitions which are not suitable for chemical or biological (macro)molecule synthesis. As in the current invention the fluids of the first circuit 18, the second circuit 20 and the third circuit 22 are maintained at target temperatures by external devices; it allows fluid mixing and thus enables to quickly reach any temperature between the threshold values of the fluids. Same applies for the embodiment comprising only a first circuit 18 and a second circuit 20.

Thus, depending on the chemical resistance of the membrane(s) 30 used, the present synthesis device 10 is very suitable for the synthesis of nucleic acids by enzymatic or chemical means, the two procedures being similar. In addition, the possibility of working at temperatures of −20° C. also makes it possible to automate certain molecular biology protocols such as DNA precipitation with ethanol. Conversely, the possibility of varying the temperature also makes it possible to consider carrying out polymerase chain reactions (PCR) or rolling circle amplification (RCA).

The main innovation of the present device 10 lies in its ability to integrate in the same device or around the same device, three essential properties for the good progress of a chemical or biochemical reaction process:
1) precise and accurate temperature control,
2) homogenization of the solution via agitation, and
3) the possibility of filtering the solution in order to purify the reaction product.

Each of these criteria can be individually validated by different devices or system of the state of the art. Of course, there are many ultrafiltration, agitation or thermoregulation systems in the state of the art. However, none of them can do all of these three tasks at the same time.

As the reaction solution does not need to be transferred to another reactor during a chemical or biological process, the device 10 according to the present invention can also easily be automated.

This combination, in one and the same device, has an undeniable advantage since it makes it possible to reduce product losses, in particular by avoiding transferring the reaction medium from one tube to another. This allows a saving of time and significant yield. With the easy possibility of automation, especially when the syntheses require several reaction cycles, such as the synthesis of nucleic acids which can reach more than 20,000 successive steps, a significant amount of time can be saved.

The device 10 according to the present invention enables the implementation of a thermocycling multistep reaction method, said method comprising, in the order of listing, following steps:
filing the first circuit 18, the second circuit 20 and the third circuit 22 with one or several heat transfer fluid(s),
activating the first pump P₁ and first thermostat T₁, second pump P₂ and second thermostat T₂, and, if present, the third pump P₃ and third thermostat T₃,
inserting, if necessary, a reaction tube inside the at least one well 14 and positioning the at least filter membrane 30 between the at least one well 14 and the evacuation system 16,
filing each well 14 with either a reaction solution or a reaction tube comprising the reaction solution,
selectively activating and disactivating over time, by means of the control unit 24, the first circuit 18, the second circuit 20 and the third circuit 22 according to a predetermined reaction protocol,
activating the evacuation system 16 when all the reaction steps according to reaction protocol are completed,
recovering the reaction product hold captive in the membrane 30 or collected in the collector.

By way of example, the thermocycling multistep reaction method is suitable for synthesis processes of organic molecules or macromolecules, which include one or a series of chemical or enzymatic reactions carried out to prepare either a single organic molecule, a library of molecularly identical organic molecules or a library of molecularly diverse organic molecules, wherein the chemical or enzymatic reactions are sequentially or cyclically performed. Such synthesis process can be implemented for the production of organic molecules such as biomolecules, including peptides, nucleic acids molecules (including DNA, RNA and mixes thereof), carbohydrates, and conjugates thereof; but could also be applied for synthesis of any other organic molecule.

Examples of synthesis process include de novo (or template-independent) synthesis, template-dependent synthesis and nucleic acid assembly.

The term “de novo synthesis” refers to a process of synthesizing an organic molecule of any length by iteratively linking organic molecule building blocks until the desired polymeric organic molecule is obtained. De novo synthesis processes apply to any type of polymeric organic molecules, including peptides, nucleic acids molecules, carbohydrates, and conjugates thereof. In de novo synthesis, the sequence of the newly synthesized organic molecule is not dictated by any template.

In the case of de novo synthesis (i.e., without template), the process typically involves the following steps which can all be carried out in the device 10 according to the invention—although one or more of these steps can be modified or adapted depending on the organic molecule to be synthesized, as will readily be apparent to the one skilled in the art:
(a) providing a synthesis initiator;
(b) contacting said synthesis initiator with at least one organic molecule building block comprising a protecting group, in conditions suitable to couple the organic molecule building block with the synthesis initiator, thereby obtaining a protected coupling product;
(c) washing the excess of protected organic molecule building block;
(d) contacting the protected coupling product with at least one deprotecting reagent in conditions suitable to remove the protecting group from the protected coupling product, thereby completing a cycle of synthesis of a polymeric organic molecule;
(e) repeating steps (b) to (d) until the desired polymeric organic molecule is obtained.

It is to be understood that the term “organic molecule building block” refers to any organic molecule, which upon sequential or cyclical coupling to other organic molecules will form a corresponding polymeric organic molecule. Typically, organic molecule building blocks include natural or synthetic building blocks, such as amino acids, nucleotides, nucleosides, monosaccharides and derivatives or analogs thereof. However, the term “organic molecule building block” may further include dimers, trimers and the like.

In one embodiment, the organic molecule building block is selected from the group comprising or consisting of an amino acid, a peptide, a nucleotide, a nucleoside, and a saccharide. In one embodiment, the protected organic molecule building block is selected from the group comprising or consisting of an N-protected amino acid, an N-protected peptide, an O-protected nucleotide, an O-protected nucleoside and an O-protected saccharide.

It is further to be understood that the term “polymeric organic molecule” refers to any organic molecule, which may be formed upon sequential or cyclical coupling to organic molecule building blocks. The nature of the polymeric organic molecule is dependent upon the identities of the organic molecule building blocks. Typically, polymeric organic molecules include biomolecules, such as, e.g., peptides, polypeptides, oligonucleotides, polynucleotides, oligosaccharides and polysaccharides. Also encompassed are conjugates thereof, such as, e.g., peptide-oligonucleotides conjugates, peptide-polysaccharide conjugates, oligonucleotide-oligosaccharide conjugates, and the like.

The term “template-dependent synthesis” applies typically to the synthesis of nucleic acids, and refers to a process that involves the synthesis of a nucleic acid strand that is complementary to a template strand of interest. In template-dependent synthesis, the sequence of the newly synthesized nucleic acid strand is dictated by complementary base-pairing with the template strand of interest.

In the case of template-dependent synthesis, and in particular in the field of nucleic acid synthesis, the process typically involves the following steps which can all be carried out in the device 10 according to the invention—although one or more of these steps can be modified or adapted as will readily be apparent to the one skilled in the art:
(a) providing a nucleotide, oligonucleotide or polynucleotide serving either as:
   a primer for synthesis of a nucleic acid strand which is complementary to at least a portion of a free nucleic acid template hybridized to said primer; or
   a nucleic acid template for synthesis of its free complementary nucleic acid strand;
(b) contacting said nucleotide, oligonucleotide or polynucleotide with at least one organic molecule building block, in particular nucleotides or nucleosides, in conditions suitable to either:
   couple the organic molecule building blocks with the nucleotide, oligonucleotide or polynucleotide serving as a primer in a complementary fashion to the free nucleic acid template; or
   couple the organic molecule building blocks to one another in a complementary fashion to the nucleotide, oligonucleotide or polynucleotide serving as a nucleic acid template;
(c) repeating step (b) until the desired nucleic acid molecule is obtained.

Typical examples of template-dependent synthesis include enzymatic amplification processes, such as polymerase chain reaction (PCR) which allows to synthetize a DNA (using, e.g., a DNA or RNA-dependent DNA polymerase) or RNA (using, e.g., a DNA or RNA-dependent RNA polymerase) strand from a nucleic acid template (such as, a DNA template or an RNA template).

The term “nucleic acid assembly” applies typically to the synthesis of nucleic acids, and refers to a process of assembling a plurality (i.e., two or more) small nucleic acid fragments to produce a longer nucleic acid fragment, using extension-based multiplex assembly reactions, ligation-based multiplex assembly reactions, or a combination thereof, in the presence of a ligase.

The thermocycling multistep reaction method is also suitable for performing molecular biology and biochemistry assays, such as, e.g., ligand-binding assays including nucleic acid hybridization assays, affinity purification, and the like.

The term “ligand binding assay” refers to a biochemical test relying on the binding of ligands to a target molecule, such as a receptor, an antibody or any other macromolecule, e.g., for screening, detecting and/or quantifying a ligand molecule binding to a given target molecule. The term “nucleic acid hybridization assay”, or in short “hybridization assay”, refers to a specific type of ligand binding assay in which the annealing of two complementary strands of nucleic acids is detected. The term “affinity purification” refers to a variant of a ligand binding assay in which a biochemical mixture is separated, based on a specific interaction between a ligand and its target molecule.

In any of the above embodiments, the method may comprise one or several downstream applications on the reaction product before it is recovered. Classical downstream applications are, for example, on-site mutagenesis, screenings, sequencing via Oxford Nanopore technology, in particular thanks to the use of the MinION® range (sequencing from linear double-stranded DNA), RNA transcription and synthesis steps, post-synthetic labelling, secured storage at low temperature without sampling, and transfer.

It is also common that the reaction solution, comprising the reaction product or its intermediate product(s), be washed, once or several times throughout the method. Typically, water or buffer can be added to the reaction product in the at least one well 14 or in the reaction tube inside the at least one well 14, and the reaction medium is then filtrated by means of the filter membrane 30 in activating the evacuation system 16. A typical washing cycle includes 2, 3 or more reiterations in a row of adding water or buffer and filtrating.

More precisely, a typical example of a thermocycling synthesis method is a scalable PCR-prep (endotoxin free/LPS free/host genome free) and direct circular plasmid production. A non-limiting example of plasmids that can be amplified using this method includes plasmids used for viral vector production. For instance, in the case of recombinant adeno-associated viral (AAV) vectors carrying a transgene of interest, production can be achieved by transfecting cells with a “rep/cap plasmid” (also termed “AAV helper plasmid”) containing the AAV rep and cap genes required for replication and capsid formation and an “AAV transfer plasmid” containing the transgene of interest flanked on both sides by inverted terminal repeats (ITRs); the cell may further be transfected with an “adenovirus (Ad) helper plasmid” containing the necessary adenovirus helper genes (in particular the virus-associated “VA” RNA, E2A and E4 genes), or alternatively be infected with a helper virus, or still alternatively, the Ad helper genes can be introduced in the AAV helper plasmid. The skilled artisan is familiar with AAV vector production.

Currently, DNA-Prep (e.g., Mini to Giga-Prep) is the most commonly used method for plasmid amplification. Robust protocols allow the obtention of high quantities of pure plasmid, easily scalable from lab bench to industrial bioreactors. However, this method is slow, labour intensive and relies on the use of bacteria, which implies an antibiotics selection step followed by an overnight culture step and finally the purification of the plasmid itself. This latter step is critical as the plasmid needs to be purified from bacterial contaminants such as genomic DNA, RNA, proteins and endotoxins.

To overcome these problems, the current device 10 enables the implementation of a fully automated synthesis method that allows high yields DNA preparations. This method is based on a process that involves a PCR-mediated amplification step followed by a sealing circularization step. Another method involves a thermostable DNA ligase that can be directly included in the PCR reaction buffer to realize a one-pot DNA-prep.

This method comprises two phases: an amplification phase by PCR, and a circularization phase by DNA-ligation. Both phases are implemented by means of the device 10 according to the current invention.

### Amplification Phase 46 by PCR:

### Materials:

thermocycled synthesis device 10,
PolyEthersulfone (PES) membrane 30 with a cut-off of 100 kDa,
Primers (forward and reverse), optionally phosphorylated,
Plasmid DNA or minicircle template (>2.5 kb),
High fidelity Polymerase (e.g., Q5® High-fidelity DNA polymerase, from New England Biolabs),
PCR buffer,
dNTPs mix,
DNase-free water.

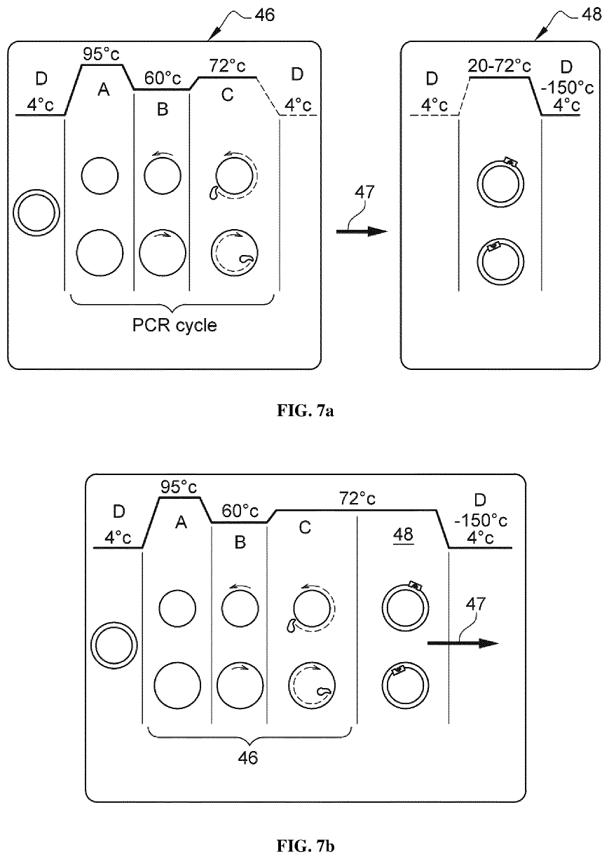

The amplification phase 46 comprises at least one PCR cycle. As can be seen on FIG. 7a, a PCR cycle comprises three phases: a denaturation phase A happening at 95° C., an annealing phase B happening at 55-70° C. and an elongation phase C happening at 72° C. FIG. 7a also shows several storage phases D which might happen at different stages of the reaction. After at least 1 to 35 PCR cycles, there is the possibility to filtrate 47 the reaction solution by means of the filter membrane 30 in activating the evacuation system 16 and thus to remove the reaction solution, in particular the primer, the dNTPs, the polymerase, and the salts, and to either pursue to the next step or to repeat one or several other PCR step(s) to increase the amount of DNA product and to remove harmful by-products, e.g., pyrophosphate may inhibit the enzymatic reaction even at very low concentrations. It has been recognized that pyrophosphorolysis, where a nucleic acid is reduced in length, is detrimental to primer extension reactions. Previous studies and invention have been assessed to overcome those limitations in adding some further reactants, which leads to a complication of the reaction protocol. The present invention enables to overcome those limitation in an easier and more efficient way.

### Circularization Phase 48 by DNA-Ligation:

### Materials:

DNA ligase (e.g., T4 DNA ligase, ATP-dependent thermostable ligase or NAD-dependent thermostable ligase such as the HiFi® Taq DNA ligase),
Example of buffer composition: 10 mM Tris-HCl, 50 mM KCl, 1 mM DTT, 0.1 mM EDTA, 50% glycerol,
Optionally, a DNA kinase when non-phosphorylated primers are used,
DNAse-free water.

If the used primers are not phosphorylated, the DNA kinase allows the phosphorylation of the 5′ ends of the double strand DNA. Thus, a DNA ligase is able to catalyse the formation of a phosphodiester bond between adjacent 5′-phosphate and 3′-hydroxyl groups of duplex DNA. This step allows the closing of the vector from linear to circular. It can be performed with different kind of ligases and at different temperatures, including T4 DNA ligase at 20° C., an ATP-dependent thermostable ligase at 70° C. or a NAD-dependent thermostable ligase at 70° C., such as the HiFi® Taq DNA ligase.

A final purification step through filtration and DNA washing is performed to remove salts, enzyme(s), nucleotides and reaction by-products.

An alternative of this method is illustrated on FIG. 7b and consists in performing a one-pot plasmid amplification and circularization by adding a thermostable NAD-dependent ligase. Such a method requires two essential features that are (1) thermostability and (2) co-factor dependency. Indeed, some thermostable DNA ligases are able to catalyse the DNA closing reaction at 72° C. and to remain stable after several incubation cycles at 95° C., similarly to thermostable polymerases. Therefore, these enzymes are compatible with PCR temperatures and can be directly included in the reaction mix. Regarding the co-factor dependency, such a feature also appears critical for optimal reaction. Indeed, there is two major families of DNA ligases that are able to use either ATP or NAD as co-factor. However, in this particular case, a thermostable NAD-dependent ligase, such as the HiFi® Taq DNA ligase, would be preferred to an ATP-dependent ligase. In contrast to NAD, ATP is structurally close to dATP and can be incorporated in the newly synthetized DNA strand by the polymerase during PCR cycles. Such a phenomenon would be very harmful since ATP is a ribonucleotide whose incorporation in place of dATP may lead to spontaneous hydrolysis of DNA.

This one-pot method performs two steps in on cycle, consisting of an amplification step by PCR and a circularization step by DNA-ligation. Both steps are implemented by means of the device 10 according to the current invention.

### One-Pot PCR/Circularization:

### Materials:

thermocycled synthesis device 10,
PolyEthersulfone (PES) membrane 30 with a cut-off of 100 kDa,
Phosphorylated Primers (forward and reverse),
Plasmid DNA or minicircle template (>2.5 kb),
High fidelity Polymerase (e.g., Q5® High-fidelity DNA polymerase, from New England Biolabs),
PCR buffer,
dNTPs mix,
NAD-dependent thermostable ligase (e.g., HiFi® Taq DNA ligase),
NAD solution,
DNase-free water.

After at least one PCR/circularization cycle (denaturation at 95° C./annealing between 55-65° C./elongation at 72° C. and circularisation at 72° C.), there is the possibility to filtrate the reaction solution by means of the filter membrane 30 in activating the evacuation system 16 and thus to remove the primer, the dNTPs, the polymerase, the NAD, the ligase, the salts and to go to the next step or repeat another cycle to increase the amount of DNA product and to remove harmful by-products. In the latter case, the reaction solution allows to renew the medium and to add fresh enzymes and to repeat cycles as many times as necessary to obtain a maximum amount of plasmid without having to use bacterial cell.

### Linear PCR Amplification

An alternative method which can be implemented using the device 10 of the invention includes linear PCR amplification. This process resembles the PCR-prep method described above, but does not comprise any circularization step. In other words, this process comprises the steps described for “Amplification phase 34 by PCR” above. The starting material may also not be a plasmid DNA or a minicircle template, but can alternatively be a linear nucleic acid template.

One particular example of linear PCR amplification is described in US 2021-0054384 A1, which is hereby incorporated by reference in its entirety. In particular, the method can comprise a step of obtaining a desired template DNA sequence containing the sequence of the gene of interest, optionally flanked by ITR sequences; then, using PCR primer pairs (forward and reverse), performing a PCR amplification as described above to produce a plurality of amplicons containing the desired sequence of the gene of interest, optionally flanked by ITR sequences. These amplicons can then be used for AAV vector production, according to methods well known in the art and mentioned above.

Other methods which can be implemented using the device 10 of the invention include RNA polymerization and “one-pot” RNA synthesis.

### RNA Polymerization:

In a first step, one or more copies, in a single-stranded DNA form, of the complementary strand of a gene to be transcribed, are provided.

Synthesis cycles can be carried out, comprising three successive steps which can be repeated several times (e.g., from 1 to 20, 30, 40, 50 or more times, or until a desired amount of final product is obtained):
a. denaturation at 95° C. of the complementary strand of a gene to be transcribed, in the presence of an RNA primer specific to the 3′ end of this complementary strand and of a thermostable RNA polymerase (e.g., the mutated Tgo DNA polymerase from Thermococcus gorgonarius described by Cozens et al., 2012. Proc Natl Acad Sci USA. 109(21):8067-72);
b. hybridization of the RNA primer on the complementary strand at a temperature ranging from about 50° C. to about 70° C.;
c. synthesis of the messenger RNA strand, complementary to the template ssDNA strand, by the polymerase, at temperatures ranging from about 60° C. to about 75° C.

Filtration of the reaction medium can be carried by means of the filter membrane in activating the evacuation system 16, in order to remove salts, nucleotides and the polymerase. Filtration can be repeated twice, three times or more, by adding water or buffer onto the sample in the at least one well 14 or in the reaction tube inside the at least one well 14, in order to wash the reaction product.

Finally, the reaction product can be incubated inside the at least one well 14 or in the reaction tube inside the at least one well 14, in the presence of an enzyme mixture able to perform a 5′ capping and a 3′ poly-adenylation to the newly produced messenger RNA, before additional rounds of washing by successive addition of water or buffer and filtration by means of the filter membrane 30 in activating the evacuation system 16; and optionally, of DNAse/protease treatment; before ultimately recovering the messenger RNA strands.

### “One-Pot” RNA Synthesis

In a first step, one or more copies, in a single-stranded DNA form, of the complementary strand of a gene to be transcribed, are provided. This complementary strand should have a plurality of deoxythymidine at their 5′ end, preferably contiguous, preferably from about 200 to about 300.

In a second step, synthesis cycles can be carried out, comprising three successive steps which can be repeated several times (e.g., from 1 to 20, 30, 40, 50 or more times, or until a desired amount of final product is obtained):
a. denaturation at 95° C. of the complementary strand, in the presence of a 5′ capped RNA primer specific to the 3′ end of this complementary strand and of a thermostable RNA polymerase (e.g., the mutated Tgo DNA polymerase from Thermococcus gorgonarius described by Cozens et al., 2012. Proc Natl Acad Sci USA. 109(21):8067-72);
b. hybridization of the RNA primer on the complementary strand at a temperature ranging from about 50° C. to about 70° C.;
c. synthesis of the messenger RNA strand, complementary to the template ssDNA strand, by the polymerase, at temperatures ranging from about 60° C. to about 75° C.

Filtration of the reaction medium can be carried by means of the filter membrane in activating the evacuation system 16, in order to remove salts, nucleotides and the polymerase. Filtration can be repeated twice, three times or more, by adding water or buffer onto the sample in the at least one well 14 or in the reaction tube inside the at least one well 14, in order to wash the reaction product.

Finally, the reaction product can be incubated inside the at least one well 14 or in the reaction tube inside the at least one well 14, in the presence of an enzyme mixture able to perform a 5′ capping and a 3′ poly-adenylation to the newly produced messenger RNA, before additional rounds of washing by successive addition of water or buffer and filtration by means of the filter membrane 30 in activating the evacuation system 16; and optionally, of DNAse/protease treatment; before ultimately recovering the messenger RNA strands.

In any of the above embodiment, and depending on the reaction carried out, the reaction product may be recovered either in the well 14 as it remains captive from the membrane 30 after the activation of the evacuation system 16, or it can be recovered from the collector, if it is the remaining reaction solution which is held captive from the membrane 30. This is the case when the reaction inside the well 14 includes some cell culture or some bigger molecule degradation in order to obtain a smaller molecule of interest.

At the end of the method, the device 10 can be used as a direct storage device (−20° C. or −80° C.).

The present invention is thus very suitable for the chemical and/or biochemical synthesis of macromolecules and small molecules bound to an organic and/or inorganic support. Each well 14 of the reaction plate 12 forms an independent synthesis chamber whose agitation and temperature are controlled, is more particularly suitable for the synthesis of polymers, such as nucleic acids, requiring cyclic chemical and/or biochemical reactions, comprising a step of addition of the reagents of synthesis, said reaction, followed by the elimination of the excess reagents as well as of the by-products of the reactions and this, in a repeated manner until the polymer of the desired size is obtained.

1. A thermocycling multistep reaction device comprising:
a reaction plate comprising at least one well aimed at receiving a reaction solution or a reaction tube, and further comprising at least one internal fluid circulation channel arranged around the at least one well,
an evacuation system,
a first circuit comprising a first pump and a first thermostat, said first circuit being activable and being aimed, when activated, at driving a first heat transfer fluid through the at least one internal fluid circulation channel, said first heat transfer fluid being at a predetermined high temperature,
a second circuit comprising a second pump and a second thermostat, said second circuit being activable and being aimed, when activated, at driving a second heat transfer fluid through the at least one internal fluid circulation channel, said second heat transfer fluid being at a predetermined low temperature lower than the high temperature,
a control unit configured to manage the activation of the first circuit and the second circuit in order to regulate and control the temperature inside the at least one well,
wherein the control unit is further configured to:
activate the first circuit in order to set and maintain the at least one well at the predetermined high temperature,
activate the second circuit in order to set and maintain the at least one well at the predetermined low temperature, and
activate both the first circuit and the second circuit in order to set and maintain the at least one well at at least one predetermined medium temperature, said at least one medium temperature being comprised between the high and the low temperature,
wherein each of the at least one well is connected to the evacuation system by means of at least one filter membrane.

2. The thermocycling multistep reaction device, according to claim 1, wherein the thermocycling multistep reaction device comprises a third circuit comprising a third pump and a third thermostat, said third circuit being activable and being aimed, when activated, at driving a third heat transfer fluid through the at least one internal fluid circulation channel, the control unit being configured to regulate and control the temperature inside the at least one well, wherein the control unit is further configured to:
activate the third circuit in order to either a rapid temperature decrease of the at least one well, or the setting and maintaining of the at least one well at a predetermined very low temperature, said very low temperature being lower than the low temperature,
activate at least two of the first circuit, the second circuit, and the third circuit in order to set and maintain the at least one well at at least one predetermined medium temperature, said at least one medium temperature being comprised between the high and the very low temperature.

3. The thermocycling multistep reaction device according to claim 1, wherein the reaction plate comprises at least two of the internal fluid circulation channels that are separated, the two channels being designed to extend symmetrically regarding each other within the reaction plate, in order to improve temperature homogeneity inside the reaction plate.

4. The thermocycling multistep reaction device according to claim 1, wherein the reaction plate comprises at least two of the internal fluid circulation channels that are separated in order to enable a crossed flow circulation of the first heat transfer fluid and the second heat transfer fluid.

5. The thermocycling multistep reaction device according to claim 1, wherein the first circuit comprises a first external fluid circulation channel, said first external fluid circulation channel bypassing the reaction plate and being connected to each of the internal fluid circulation channels by means of a first activation valve, the opening of the first activation valve leading to the activation of the first circuit.

6. The thermocycling multistep reaction device according to claim 1, wherein the second circuit comprises a second external fluid circulation channel, said second external fluid circulation channel bypassing the reaction plate and being connected to each of the internal fluid circulation channels by means of a second activation valve, the opening of the second activation valve leading to the activation of the second circuit.

7. The thermocycling multistep reaction device according to claim 2, wherein the third circuit comprises a third external fluid circulation channel, said third external fluid circulation channel bypassing the reaction plate and being connected to each of the internal fluid circulation channels by means of a third activation valve, the opening of the third activation valve leading to the activation of the third circuit.

8. The thermocycling multistep reaction device according to claim 1, wherein the predetermined high temperature ranges from about 90 to about 110° C.

9. The thermocycling multistep reaction device according to claim 1, wherein the predetermined low temperature ranges from about −150 to about 19° C.

10. The thermocycling multistep reaction device according to claim 1, wherein the device comprises one of the filter membrane for the entire reaction plate which displays the same surface as the reaction plate and connects the at least one well to the evacuation system.

11. The thermocycling multistep reaction device according to claim 1, wherein the device comprises one of the at least one filter membrane for each of the at least one well of the reaction plate, each membrane connecting each corresponding well to the evacuation system.

12. The thermocycling multistep reaction device according to claim 1, wherein each of the at least one well forms an independent reaction chamber.

13. The thermocycling multistep reaction device according to claim 1, wherein the device comprises an integrated steering system.

14. A thermocycled multistep method implemented by means of the thermocycling multistep reaction device according to claim 1, said method comprising, in the order of listing, following steps:
filling the heating circuit, the reaction circuit and the third circuit with one or several heat transfer fluid(s),
activating the first pump and first thermostat and the second pump and second thermostat,
filling each of the at least one well or each reaction tube with a reaction solution,
selectively activating and disactivating over time, by means of the control unit, the first circuit, and the second circuit according to a predetermined reaction protocol,
activating the evacuation system when all the reaction steps according to reaction protocol are completed, and
recovering the reaction product.

15. The method according to claim 14, wherein the method comprises a downstream application on the reaction product before it is recovered.

16. The method according to claim 14, further comprising inserting a reaction tube inside the at least one well and positioning the at least one filter membrane between the at least one well and the evacuation system, wherein the inserting occurs after the activating of the first pump and first thermostat and the second pump and second thermostat and prior to the filling of each of the at least one well.
